(19) United States
(12) Patent Application Publication
(10) Pub. No.: US 2004/0246135 A1
(43) Pub. Date: Dec. 9, 2004

(54) Traveller

(76) Inventor: Harold Ralph Carey, Huntsville, AL (US)

Correspondence Address: Harold R Carey, 9002 Berclair Road, Huntsville, AL, 35802, US

(21) Appl. No.: 10/250,167

(22) Filed: Jun. 9, 2003

(51) Int. Cl. G08B 23/00

(52) U.S. Cl. 340/573.1

(57) ABSTRACT

The Traveller is a multi-function device to aid blind people in unassisted walking. It provides 4 inter-related functions: (1) A magnetic compass, marked in braille to help a blind person orient himself, or to face and walk in a selected direction. (2) A straight-walker to guide the blind person to walk in a selected direction, using vibrators in the neck-strap at the side of the neck. (3) An obstacle alarm to signal the blind person that an obstacle is ahead at nearer that the pre-selected distance, using a vibrator at the back of the neck. (4) A queue-minder using a vibrator at the back of the neck, to signal the blind person while standing in a queue that the person in front has moved up.

### FEDERAL RESEARCH STATEMENT

This invention is not related to any federally funded research or development.

### BACKGROUND OF INVENTION

Blind people usually use a long cane to help them detect obstacles in front of them when they are walking unassisted. This works fairly well, but the long cane cannot help them walk in a straight line in a large open area like a hotel lobby, a shopping mall, or a parking lot. Some blind people have said that it would be very useful to have a device to assist them to walk unaided in a straight line in an open area. There is nothing available at a reasonable cost to do this.

Sometimes blind people have a need to walk in a particular direction of the compass. Some blind people have said that it would be very useful to have a compass that would guide them to face and walk an exact direction. There is nothing available at a reasonable cost to do this. There are talking compasses available, but they only report the four ordinal compass points N, S, E, W., and they are expensive.

The long cane can detect objects that are large, but sometimes blind people collide with narrow objects (such as street sign posts) that they miss with their cane. Also, they sometimes collide with objects that are high off the ground (such as tree limbs), because their cane is feeling for objects near the ground. Some blind people have said that it would be very useful to have a device to warn them of chest-high objects or narrow obstacles at a sufficient distance to avoid them. There is available at a reasonable cost to do this.

Sometimes a blind person standing in a queue (for example, at a concert or at a grocery checkout) needs to know when the person in front of him has moved up in line. (The only way currently is to constantly tap the heels of the person in front.) Some blind people have said that it would be very useful to have a queue minder to signal them to move up in line when the person in front has moved up. There is nothing available at a reasonable cost to do this.

This invention is an Electronic Travel Aid to solve all of these related problems with a single device.

### SUMMARY OF INVENTION

The Traveller has four related function:

1. A magnetic compass, marked in braille to help a blind person orient himself, or to face and walk in a selected direction.

2. A straight-walker to guide the blind person to walk in a selected direction, using vibrators in the neck-strap at the side of the neck.

3. An obstacle alarm to signal the blind person that an obstacle is ahead at nearer that the pre-selected distance, using a vibrator at the back of the neck.

4. A queue-minder using a vibrator at the back of the neck, to signal the blind person while standing in a queue that the person in front has moved up.

Traveller Design Features:

1. The Traveller is worn at the user's chest, to that both of his hands are free to use his cane and/or handle his guide dog.

2. The Traveller uses vibrators in the neck-strap, instead of sound, so that the user can listen to his environment. Blind people have said that they do want anything that interferes with their normal hearing of their environment, because they depend on hearing so strongly.

3. The Traveller has a compass knob marked in braille, so that the user can accurately set a course.

4. The Traveller uses a sensitive sonar with a wide beam, and therefore will detect any object in front that is in range, even as an object narrow as a sign post.

### BRIEF DESCRIPTION OF DRAWINGS

FIG. 1 shows a schematic drawing of the Traveller. Item 1 is the case which houses the battery-powered electronics, and is worn on the user's chest. It is suspended by a Neck-Strap, Item 5. The Neck-Strap is hollow, and contains a small Vibrator at the back of the neck (Item 4), and a Vibrator at each side of the neck (Items 9 and 10).

The Sonar unit (Item 2) detects objects in front of the user. It sends a signal to the Distance Adjustment unit (Item 3), which signals the Vibrator at the back of the neck (Item 4). If the device is set to Obstacle-Alarm Mode, the vibrator is active when an object is closer than the selected distance adjustment. If the device is set to Queue-Minder Mode, the vibrator is active when an object (usually the person in front in a queue) is beyond the selected distance adjustment.

The Electronic Compass (Item 6) sends a signal to the Deadzone Adjustment unit (Item 7) when the person is facing the wrong direction. The user can adjust the Deadzone from very wide (about 20 degrees) to zero. In turn, the Deadzone Adjustment unit sends a signal to the appropriate Vibrator (Item 8 or Item 9) to signal the user to turn back to the selected direction.

### DETAILED DESCRIPTION

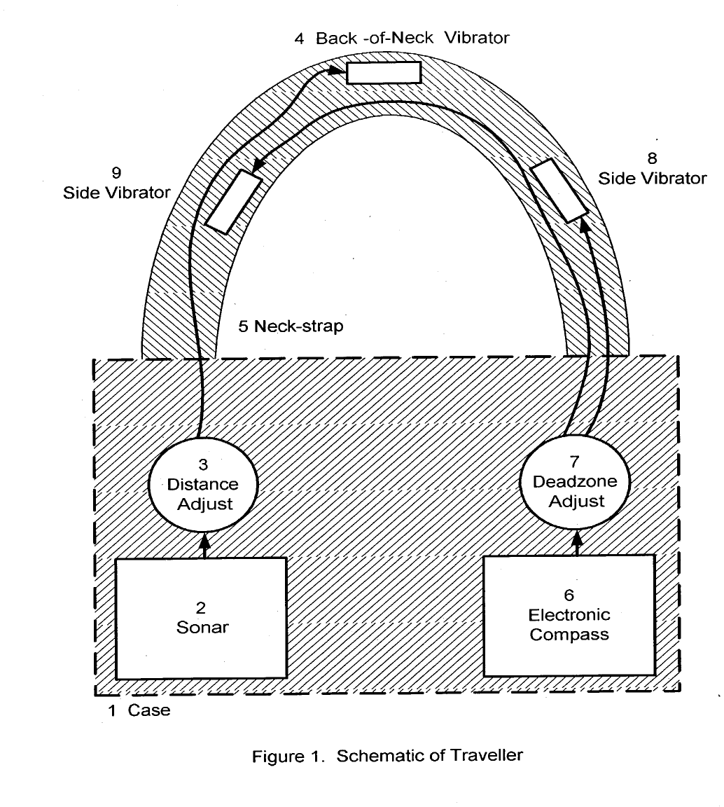

FIG. 1 shows a schematic drawing of the Traveller. Item 1 is the case which houses the battery-powered electronics, and is worn on the user's chest. It is suspended by a Neck-Strap, Item 5. The Neck-Strap is hollow, and contains a small Vibrator at the back of the neck (Item 4), and a Vibrator at each side of the neck (Items 9 and 10).

The Sonar unit (Item 2) detects objects in front of the user. It sends a signal to the Distance Adjustment unit (Item 3), which signals the Vibrator at the back of the neck (Item 4). If the device is set to Obstacle-Alarm Mode, the vibrator is active when an object is closer than the selected distance adjustment. If the device is set to Queue-Minder Mode, the vibrator is active when an object (usually the person in front in a queue) is beyond the selected distance adjustment.

The Electronic Compass (Item 6) sends a signal to the Deadzone Adjustment unit (Item 7) when the person is facing the wrong direction. The user can adjust the Deadzone from very wide (about 20 degrees) to zero. In turn, the Deadzone Adjustment unit sends a signal to the appropriate Vibrator (Item 8 or Item 9) to signal the user to turn back to the selected direction.

1. What I claim as my invention is a multi-function device to aid blind people in unassisted walking. It provides 4 inter-related functions:
A magnetic compass, marked in braille to help a blind person orient himself, or to face and walk in a selected direction.

2. A straight-walker to guide the blind person to walk in a selected direction, using vibrators in the neck-strap at the side of the neck.

3. An obstacle alarm to signal the blind person that an obstacle is ahead at nearer than the pre-selected distance, using a vibrator at the back of the neck.

4. A queue-minder using a vibrator at the back of the neck, to signal the blind person while standing in a queue that the person in front has moved up.
